(19) United States
(12) Patent Application Publication
(10) Pub. No.: US 2007/0135946 A1
(43) Pub. Date: Jun. 14, 2007

(54) Command and argument description display corresponding to user actions on an electronic instrument

(76) Inventors: Toshio Sugiyama, Shizuoka (JP); Toru Takai, Tokyo (JP)

Correspondence Address: WILLIAM K. BUCHER;TEKTRONIX, INC., 14150 S.W. KARL BRAUN DRIVE, P.O. BOX 500, MS 50-LAW, BEAVERTON, OR, 97077, US

(21) Appl. No.: 11/603,447

(22) Filed: Nov. 22, 2006

(30) Foreign Application Priority Data
Nov. 25, 2005 (JP) 2005-341281

(51) Int. Cl. G05B 15/00

(52) U.S. Cl. 700/83

(57) ABSTRACT

An electronic instrument displays commands and arguments and their description related to specific user operations of an electronic instrument. A command help bar is displayed in a window with the command help bar displaying a command and associated argument and a description of the command and argument as a function of user defined operations of the electronic instrument using operation means. The user entered value is used as the argument, which allows the user to easily understand a specific description. The user may access additional help windows that displays information on a detailed explanation of the description method (syntax) of the displayed command and a programming example. The description of the command and argument including the specific setting value may be copied and pasted into a program file in a programming widow that is displayed at the same time, which enhances programming efficiency.

### BACKGROUND OF THE INVENTION

The present invention relates generally to electronic instruments and more particularly to a electronic instrument that displays commands and arguments and their description related to user selected actions for programming the electronic instrument to perform the corresponding actions.

A microprocessor-equipped electronic instrument, such as a signal generator, oscilloscope or the like, accesses programs stored on a hard disk drive and provides the program instructions to a memory, such as RAM, for execution by the microprocessor. The electronic instrument has a display, such as a liquid crystal display (LCD) or the like, and operation means, such as keys, knobs and the like. A user operates the keys and knobs to make the instrument execute various actions. The user can also write program code to make the instrument execute the same actions. Many of the current electronic instruments are provided with generally available operation system software (OS), such as Microsoft Windows, Linux or the like, for controlling the basic operations of the instrument, such as access to program, input from keys and the like. Generally, such operating systems allow the opening multiple display windows. Various software applications compatible with the operating system software are available for use with the operating system software.

FIG. 1 is a block diagram of a typical signal generator as an example of an electronic instrument. The signal generator provides arbitrary output signals, such as a sinusoidal waveform, square wave, ramp or the like, according to user settings. The output signals from the signal generator may be applied to a circuit under test to determine if the test circuit is functioning properly. That is, the signal generator provides a test signal to the circuit under test and the output of the circuit is measured by oscilloscope, or the like to confirm whether the circuit is working properly.

With reference to FIG. 1, a central processing unit (CPU) 10 controls the operation of the instrument according to programs stored on a hard disk drive (HDD) 14. A memory 12, such as RAM memory, is used for a work area for the CPU 10 to read programs from the storage device 22. A user can set up the signal generator via operation means 24 that include keys, knobs, and the like. A display 22 provides visual information relating to signal patterns and user settings. An external display output circuit 20 provides a video output which may be connected to an external display 32 for providing a larger display area in addition to the built-in display 22 of the signal generator. A waveform generation circuit 16 generates signal patterns based on user defined parameters. In this example, the waveform generator circuit has two channel outputs and inputs for trigger and event signals. Receipt of these signals enables a conditional action to be described below. An inpuvoutput port 28 is used for connecting an external keyboard 29, a pointing device, such as a mouse 30, and the like to the signal generator. The external keyboard 29 and/or mouse 30 may be included as part of the operation means of the signal generator. These blocks are coupled together via a bus 18. The bus 18 of the signal generator may have a General Purpose Interface Bus (GPIB) interface 26 for connecting the signal generator to an external controller, such as a personal computer (PC) 34. The external PC 34 allow the signal generator to be remotely controlled. Alternatively, a Local Area Network (LAN) interface may be used for the GPIB interface 26, which enables the external PC to control the signal generator over a network.

The signal generator outputs signal patterns according to a sequence that the user sets. FIG. 2 shows a window 35 of a table of an output sequence on the display device 22 for channel 1 (CH1) and channel 2 (CH2) waveform signal patterns. The output sequence is designated by indexes that are labeled as 1, 2, 3 . . . n or the like The user assigns a desired signal pattern to each index for each channel with a signal pattern name. The signal generator outputs the signal patterns according to the order of the indexes and terminates the signal output when the signal pattern of the last index is over. A slider 38 on a scroll bar 36 is provided and moved up or down by a mouse, keyboard control or the like. A desired portion of the sequences in the table can be selectively displayed by moving the slider 38 to a selected index. The display of FIG. 2 may be a window on the display 22.

The table of FIG. 2 allows the user to set up the signal generator to provide a more complex output signals using sequence control parameters, such as “Trigger Wait”, “Loop”, conditional “Event Jump”, “Go To”, and the like. Index 3 shows “Trigger Wait” is “ON”. The signal patterns of indexes 1 and 2 are provided as outputs and then the signal generator suspends the outputs. If a trigger signal that satisfies user settings is provided to the trigger input terminal, the signal generator resumes the outputs from the signal patterns designated by the index 3. Index 5 shows a “loop” 100 and a conditional “Event Jump” set to 15. The sequence jumps to index 15 if the sequence reaches index 5 and an event signal satisfying user settings is provided to the event input terminal during the 100 repeats of the signal patterns designated by index 5. Alternatively, if the event signal is not provided during the 100 repeats of the signal patterns of index 5, the sequence proceeds to index 6. Index 6 is designated to advance to index 20 by an unconditional jump, or “Go To” so that when the outputs of the signal patterns designated by index 6 has finished, the sequence jumps to the index 20. The sequence control parameters may be incorporated into a computer program operating on an external controller that controls the generation of the output signals from the signal generator.

FIG. 3 is a representative front panel of a signal generator for generating output signal patterns. Most elements of the operation means 24 exist on the front panel. The built-in display 22 has the display screen 40. A power button 42 is pressed to apply power to the signal generator. The first channel is provided with differential outputs 44 and 46. Similarly the second channel is provided with differential outputs 48 and 50.

A sequence start (or Run) key 52 initiates a sequence circuit in the waveform generation circuit 16 to generate the signal patterns that are output from each channel output according to the sequence settings. Note that the sequence settings may have the trigger wait status so that even when the sequence circuit is working, signals may not always be output. An On/Off key 54 controls relays in each of the output channels to turn on and off the signal outputs of the channels. Keys 56 and 58 control the respective relays in the first and second channel output portions to turn off the respective channel outputs. Keys 60 and 62 are used to select one of the first and second channels when the signal pattern is set or edited. The display screen 40 has a touch screen that is turned on or off using operation key 64. If the touch screen is “ON” the user can operate the signal generator by touching desired portions on the screen 40.

Trigger and event inputs 66 and 68 are provided for receiving respective trigger and event signals. A user may set trigger and event signal parameters displayed on the screen 40 using elements of the operation controls 24. The signal parameters may be a voltage level to exceed, polarity (rising or falling) of an edge, for example. Keys for frequently used parameters of the signal settings, such as sampling rate, amplitude and offset, are prepared as hardware keys 70, 72 and 74 respectively. The sampling rate is a parameter that how many data points the output signal has for one second.

A rotary knob 78 is typically used for changing variable settings. Arrow keys 80 and 82 are used for selecting one of the digits of numeric values for modification. 84 is a numeric keypad. 86 is a keypad of frequently used units. Keys 88, 90, 92 and 94 are Cancel, Backspace, Delete and Enter keys respectively. USB ports 96 and 98 are provided for connecting the external keyboard 29, the mouse 30, and for exchanging data via a USB memory. In addition to the front panel, the back panel (not shown) may contain USB ports.

The above signal generator is preferably based on hardware and software similar to a personal computer with an additional special function of signal generation. Therefore, the display screen 40 can display multiple windows. For example, windows for setting/executing signal generation, for programming and for word-processing may be opened at the same time with data and text being exchanged between windows by copy and/or paste as is well-known.

The signal generator may be controlled by an external controller, such as the PC 34, using an external control program. The external control program is prepared in advance and stored on a HDD (not shown) of the PC 34 and read out via the GPIB interface 26 or the like. A user creates the external control program by describing signal generator commands in a command script file. The signal generator receives the commands from the PC 34 via the GPIB interface 26 and performs the instructions described in the commands. The programming of the external control program may be done using the PC 34 or if programming software is installed into the signal generator, the programming can be done using the signal generator and then the resulting program transferred to the PC 34.

Manufacturers of the signal generators usually prepare a user manual of remote commands for the user convenience of using the remote commands. The user may refer to the remote command manual to learn the descriptions of the commands for desired actions and the arguments for the programming the actions. However, the user may not have the user manual available for a reference. Even if the manual is available, it may take time to find the command for the desired action of the signal generator. Further, the user may find a command that seems to correspond to the desired action, but is unsure if the command and the argument description really correspond to the desired action. In this case, the only way to confirm the action is to execute the created program.

Some methods are known for helping user understanding of the command usage. For example, Japanese publication No. 5-119893 discloses an invention relating to editor operation. If a mode is changed to a help mode by pressing a help key and one of keys is pressed, help data of the command or function of the pressed key or the neighbor keys is displayed on a display means. The editor of the embodiment requires inputs of “Ctrl and “s” keys at the same time to conduct a search command”. If the user does not remember the “Ctrl” and “s” key operation corresponding to the search command, the user may change the mode to the help mode and do the “Ctrl” and “s” key operation, then an explanation of the command corresponding to the key operation being “search” and the function of the search is displayed.

Another example is shown in the E1961A Online User's Guide for the 8960 Series 10 Wireless Communications Test Set with AMPS/136 (E1961A) Test Application, manufactured by Agilent Technology, Inc., Santa Clara, Calif. The application software uses commands called “GPIB command” that makes the 8960 series work as a user desires. Even if the user does not know which GPIB command is appropriate, pressing of the “HELP” key on the 8960 Series 10 body initiates a help mode and the GPIB commands corresponding to the keys or knob actions are displayed on the display screen. The Online User's Guide provides an example where the user navigates to an Audio Generator Instrument Screen and presses an “F3” key corresponding to the frequency setting during the help mode, then a command corresponding to the action “AFGenerator: FREQuency” is displayed.

To use the “AFGenerator: FREQuency” command in a program, the command is followed by an argument and a unit of measure, such as a 10 followed by one of Hz, KHz, MHz and GHz resulting in the command and argument “AFGenerator: FREQuency 10 KHz”. To know how to designate the argument, the user may look up “AFGenerator: FREQuency” as a keyword in a command syntax guide such as “GPIB command Syntax for E1961A AMPS/136 Mobile Test Application Revision A.07” by Agilent Technologies, Inc.

The commands of the invention disclosed in the Japanese publication No. 5-116893 are for the editor operations so that it does not include arguments. It does not matter how to describe the commands in the program for the simple operation commands; it is just one operation to one command without the argument. The help mode adopted by the 8960 Series 10 Wireless Communications Test Set, Agilent Technologies, Inc. provides only command description on the display corresponding to an action but does not describe the arguments so that actual usage of the commands is not described. That is, the help function provides only a keyword that the user can look up a relevant item in the command syntax guide for a specific description of the commands and arguments.

Therefore, it is desired for a user to easily access specific usage information of a command including the relevant arguments to make an electronic instrument work as the user desires, which improves programming efficiency.

### SUMMARY OF THE INVENTION

The present invention relates to an electronic instrument that has display and operation means and executes a desired action according to a program. The electronic instrument displays command and argument description for programming the electronic instrument to make the instrument perform a desired action in the same manner as the user operates the instrument through the operation means. In addition to the command and argument, explanation of the argument may be displayed at the same time.

Further, the present invention relates to an electronic instrument that executes a program to conduct a desired action. The electronic instrument has display means, operation means, memory means and control means. The memory means stores command and argument description for programming the desired action as operated through the operation means. The control means reads the command and argument description from the memory means corresponding to the desired action when the desired action is done by the operation means to make the display means displays the command and argument description.

In response to a user operation, an electronic instrument of the present invention displays information on the command and argument corresponding to the operation, and an explanation of their description or usage wherein a user setting value is used as the specific argument so that the user easily an intuitively realizes a specific description method of the command while considering the operation. The display means may display a plurality of windows and one of the windows displays the description of the command and argument including a specific setting value. The user may copy the command and argument into a command script file in another window. Therefore, the present invention enhances programming efficiency.

The objects, advantages and other novel features of the present invention are apparent from the following detailed description when read in conjunction with the appended claims and attached drawings.

### BRIEF DESCRIPTION OF THE DRAWINGS

FIG. 1 is a block diagram of a typical signal generator as an example of an electronic instrument.

FIG. 2 is a display for sequence settings by table style.

FIG. 3 is a front panel of a signal generator suitable for implementing the present invention.

FIG. 4 is a display example on an electronic instrument according to the present invention.

FIG. 5 is graphical explanation to access to detailed help description on a command.

FIG. 6 is a flow chart of display processes according to the present invention.

### DETAILED DESCRIPTION OF THE INVENTION

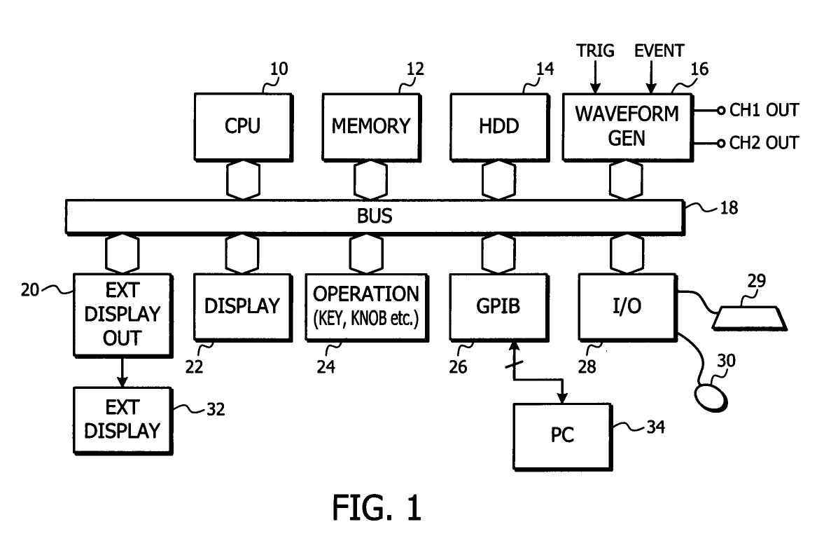

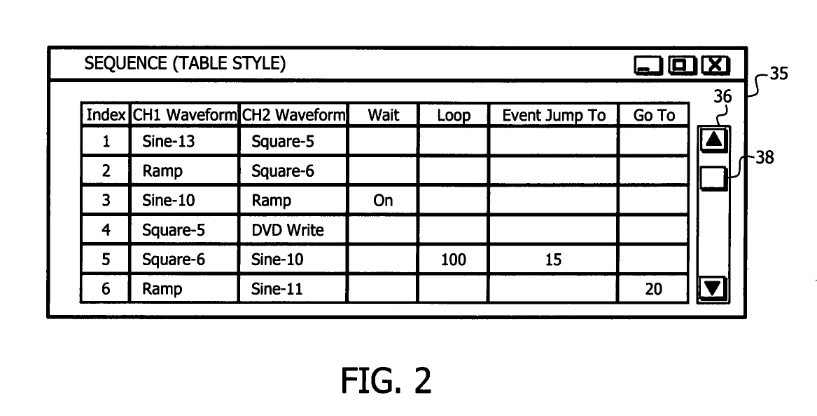

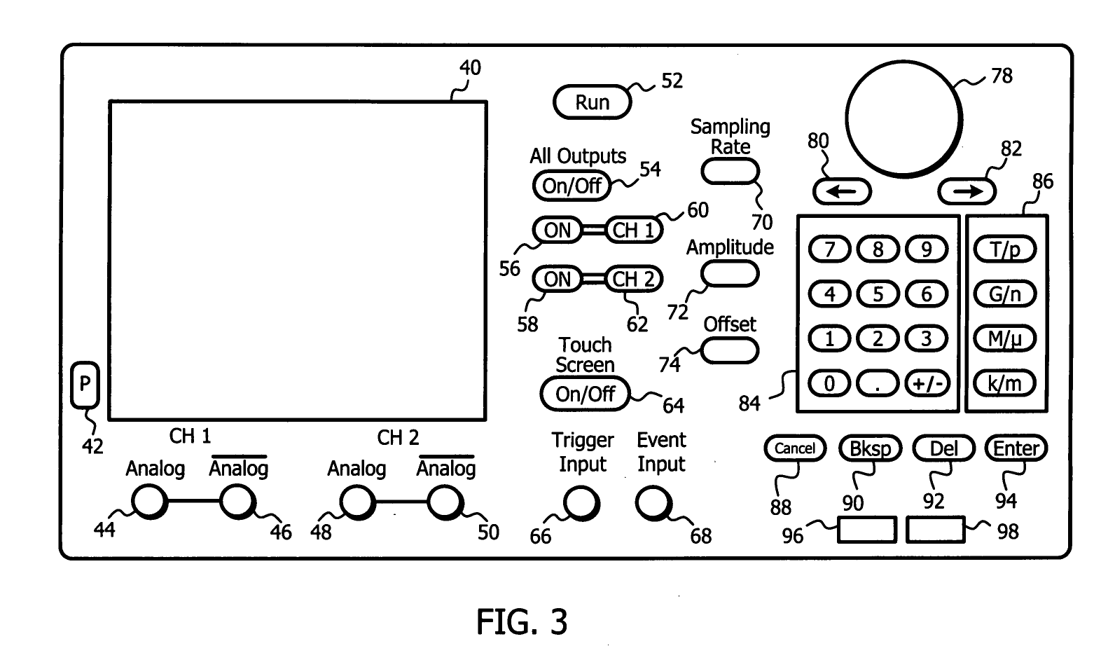

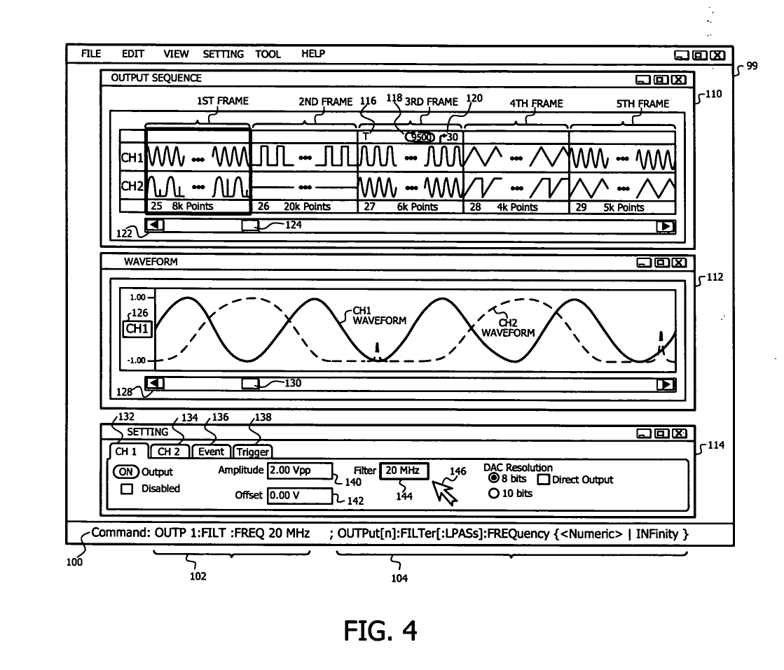

FIG. 4 shows a representative display window 99 according to the present invention. An embodiment of an electronic instrument according to the present invention has the capability of displaying multiple windows on a display device. In the below description, the electronic instrument is a signal generator having a block diagram as in FIG. 1, a table for sequence setting as in FIG. 2 and a front panel as in FIG. 3 The display window 99 is used for settings, signal pattern edit and the like related to signal generation. In addition to the display window 99, other display windows (not shown), such as a programming window, may be displayed. Data from one display window may be copied and pasted to another window.

The electronic instrument or signal generator according to the present invention features a help display area, or command help bar 100 that displays commands and arguments on the display screen 40. The commands and arguments are program codes for instructing the electronic instrument to perform a desired function. The command help bar 100 displays the command and argument for the same action as conducted by the user-operation through one of the operation means including the built-in operation means 24, the screen 40 of the display means 22 and, if necessary, external keyboard 29, mouse 30 and the like. This allows a user to easily knows how to describe the command for the specific operation that the user conducts. The displayed command and argument may be copied and pasted into a command script file being written that is displayed in the programming window. It should be noted that the specific argument corresponding to the user actual operation is included in the description of the command and argument. Thus, the user can realize both the specific action for the signal generator and the corresponding command description for programming the signal generator, which enable the user to reach more appropriate programming description faster.

As an example of how the command help bar 100 functions, command “OUTP 1:FILT:FREQ 20 MHz”, indicated by bracket 102, is a command that causes the signal generator to filter an output of the first channel by low-pass filter having a cutoff frequency of 20MHz. A description of the command “OUTPut[n]:FILTer[:LPASs]:FREQuency {<Numeric>|INFinity}”, indicated by bracket 104, explains the command and argument including the specific numeric value indicated by the command 102. A skilled user would realize the meaning of the command 102 having the specific numeric value in place of the argument by considering the description of the command 104 and the user's operation of the signal generator. Especially, if there are arguments the bracket 104 information assists the user to understand their meanings.

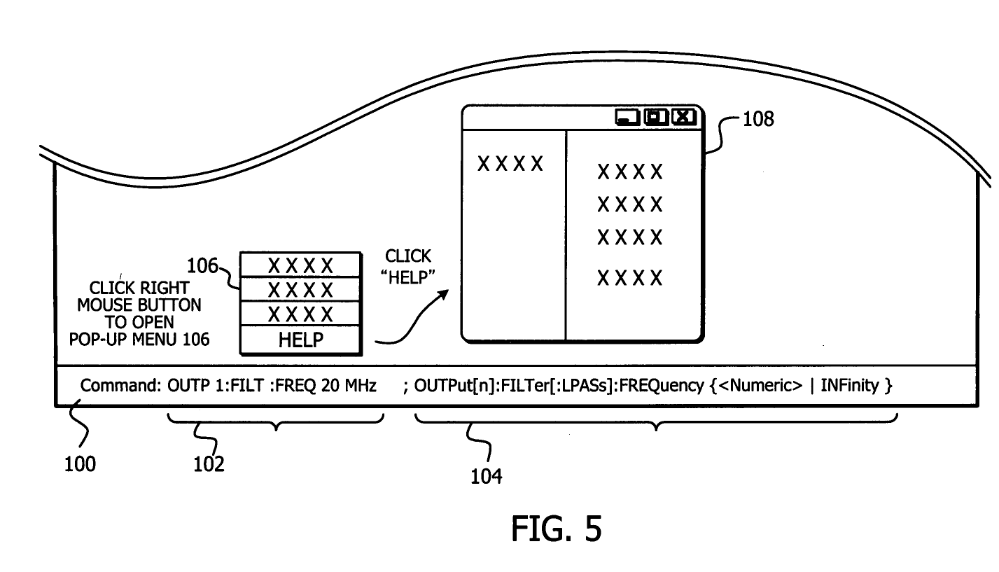

If the command description 104 is not enough for the user to understand the command 102, the user can position the mouse pointer on the display area of the command 102 and click the right button of the mouse to open a pop-up menu 106 as shown in FIG. 5. The user may then position the mouse pointer on the “HELP” item and click the mouse button to opens a window 108 that displays information on a detailed explanation of the description method (syntax) on the displayed command and a programming example. The user may read the explanation on the interested command within the window 108 to understand that “n” of “[n]” is the number of the channals, omission of “n” means 1, FILTer[:LPASs]means a lowpass filter, “Numeric” of “FREQuency {<Numeric>|INFinity}” is used for entering numeric value of a cut-off frequency, “|” indicates another choice is described in parallel and the description of “INFinity” instead of “<Numeric>” makes the cut-off frequency infinity, which is equivalent to a lowpass filter. FIG. 5 omits windows 110, 112 and 114 shown in FIG. 4 for simplicity.

The windows 110, 112 and 114 are described below with referring to FIG. 4. The window 110 shows signal patterns of the output sequence as waveforms. It provides the same level setting circumstance as the table style shown in FIG. 2 and further has an advantage that the user can visually check the settings of the output sequence using the waveforms. Sequence control icons 116, 118 and 120 indicate trigger wait, 9500 time loops and unconditional jump (Go To) to an index 30, respectively. Five frames are shown with the bottoms of the frames showing index numbers 25 through 29 and point numbers (e.g. the first frame has 8k points) of the respective frames. A slider 124 on scroll bar 122 may be moved along the scroll bar 122 to selectively display desired index frames of the output sequence. Frame index 25 is shown with a thick frame indicating that frame index 25 is selected.

The window 112 shows the first channel signal pattern (solid line) and the second channel signal pattern (dotted line) of the frame index 25. The signal pattern of the first channel is under setting/edit status as indicated by a box 126, which results from operation of the mouse 30 or the first channel select button 60 on the front panel shown in FIG. 3. The settings of the first channel signal pattern of the frame index 25 may be changed by deforming the waveform of the signal pattern using the mouse 30 or changing the settings using the window 114. A slider 130 on scroll bar 128 may be moved to selectively display desired portions of the signal pattern waveform.

The window 114 has a number of tabs 132,134, 136, and 138 for setting parameters for channel 1 (CH1), channel 2 (CH2), Event, and Trigger. FIG. 4 shows the channel 1 (CH1) tab selected to enable the first channel settings to be changed. The channel 1 (CH1) tab 132 shows the user selecting a low pass filter setting of 20 MHz in the low pass filter setting box 144 by using a mouse cursor 146 and entering 20MHz using the keypads 84 and 86 on the front panel or by the external keyboard 29. The command help bar 100 displays the command and argument (the actual numeric value is used) corresponding to the above operations and the explanation as indicated by the bracket 104.

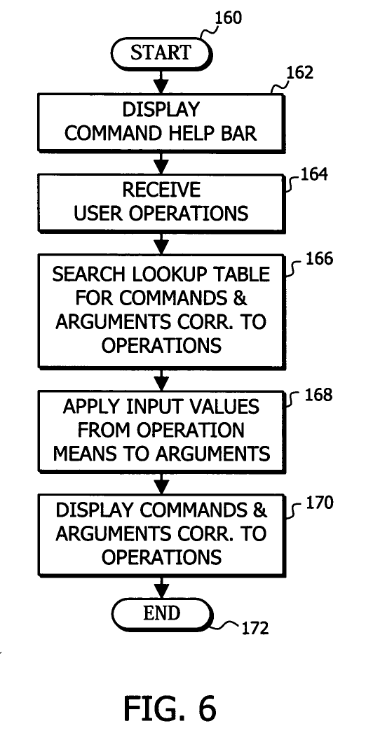

FIG. 6 is a flow chart illustrating the steps in display processes of the signal generator according to the present invention. The command help bar 100 can be turn on and off as needed. The command help bar 100 is turned on (step 162) by selecting a “Command Help Bar” in a “VIEW” menu of the tool bar of the window 99. The user sets-up the signal generator through display graphic elements on the display screen 40 using the knobs and keys of the operation means 24 and/or the external keyboard 29 or mouse 30 with the signal generator receiving the user specified operations (step 164). The display graphic elements have indexes into a lookup table which is searched for the command and argument(s) corresponding to the operations, and for information explaining the usage description of them. The lookup table is stored in the HDD 14 and read out to the memory 12 such as a RAM so that the CPU 10 can quickly accesses it during the operations. The CPU 10 applies the setting value entered through the operation means to the argument (step 168) and makes the command and argument and the information how to describe them display on the command help bar 100 (step 170). Alternately, the information of the command, argument and their description may be embedded into a property of the corresponding display graphic element during the programming, and then the information is read out during the user operations (step 164).

As described above, the present invention provides a command help bar in a window on a display screen and displays a description method, or usage of command, argument, and their explanation. User input setting values are used as the specific arguments so that the user easily and intuitively understand specific description methods of the commands while performing the signal generator set-up operations. The display screen can display a plurality of windows and the user copies the description of the command and argument including the specific setting value on the command help bar in the window and pastes it into program file displayed in a programming widow. Therefore, the present invention enhances programming efficiency.

Although the invention has been disclosed in terms of the preferred and alternative embodiments disclosed herein, those skilled in the art will appreciate that modifications and improvements may be made without departing from the scope of the invention.

What is claimed is:

1. An electronic instrument comprising:
operation means for controlling the electronic instrument to perform a desired action;
means for displaying command and argument description of the desired action for programming the electronic instrument to perform the same desired action as operated through the operation means.

2. The electronic instrument recited in claim 1 wherein the command and argument displaying means further comprises displaying an explanation of the argument.

3. The electronic instrument recited in claim 1 wherein the argument is a specific value entered for the desired action.

4. The electronic instrument recited in claim 1 wherein the electronic instrument is a signal generator.

5. The electronic instrument recited in claim 1 wherein the display means displays a command help area in a window and a programming window, the command help area displaying the command and argument description corresponding to the desired action, and the command and argument description being copied and pasted into command script file in the programming window.

6. The electronic instrument recited in claim 1 further comprising a lookup table stored in a memory means of the electronic instrument having information on the command and argument description relating to the corresponding desired action, with the electronic instrument searching the lookup table for the command and argument description corresponding to the desired action.

7. The electronic instrument recited in claim 1 wherein a graphic element corresponding to the desired action stores the corresponding command and argument description in the property and the command and argument description is displayed on the display means during the desired action by reading it from the property.

8. The electronic instrument recited in claim 1 wherein the command and argument description is a remote command and argument description used in an external controller coupled to the electronic instrument with the external controller storing the desired action command and argument description for remotely controlling the electronic instrument.

9. An electronic instrument operating under program control for performing a desired action comprising:
display means;
operation means;
memory means for storing command and argument description for programming the desired action as operated through the operation means; and
control means for reading the command and argument description from the memory means corresponding to the desired action when the desired action is done by the operation means to make the display means displays the command and argument description.
